(19) United States
(12) Patent Application Publication
(10) Pub. No.: US 2006/0280191 A1
(43) Pub. Date: Dec. 14, 2006

(54) Method for verifying and creating highly secure anonymous communication path in peer-to-peer anonymous proxy

(75) Inventors: Kai Nishida, Chikusa-ku (JP); Yoshinori Hijikata, Osaka (JP)

Correspondence Address: EDWARDS & ANGELL, LLP, P.O. BOX 55874, BOSTON, MA, 02205, US

(73) Assignees: Kai Nishida (90%), Chikusa-ku (JP); Yoshinori Hijikata (10%), Osaka (JP)

(21) Appl. No.: 11/506,561

(22) Filed: Aug. 17, 2006

Related U.S. Application Data
(63) Continuation of application No. PCT/JP05/03242, filed on Feb. 21, 2005.

(30) Foreign Application Priority Data
Feb. 19, 2004 (JP) 2004-077168

(51) Int. Cl. H04L 12/56

(52) U.S. Cl. 370/401; 370/352

(57) ABSTRACT

This invention provides a communication method. The method comprises: providing a terminal anonymous proxy server that functions as a user terminal for a specific user and also functions as an anonymous proxy server for a user other than the specific user via a network; creating an encrypted anonymous communication path from the terminal anonymous proxy server to a destination anonymous proxy server directly connected to a destination server that the specific user desires to communicate with via at least one relay anonymous proxy server; creating an encrypted anonymous verification paths from the terminal anonymous proxy server to each of the at least one relay anonymous proxy server and to the destination anonymous proxy server, the encrypted anonymous verification paths being different from the encrypted anonymous communication path, the encrypted anonymous verification paths being for verifying the encrypted anonymous communication path; and verifying the encrypted anonymous communication path based on a preservation of an identity of a password when being transmitted via the encrypted anonymous verification path.

### TECHNICAL FIELD

The present invention relates to a communications processing device, communications system, and program able to ensure a highly secure anonymous communication path in a computer network.

### BACKGROUND ART

A communication method that relies on the TCP/IP protocol used for the Internet and the like enjoys widespread use worldwide. Owing to its simple architecture, this communication method represents a standard that is easily adapted to various kinds of devices (FIG. 2).

Typically, the majority of communications data transmitted over the Internet is unencrypted, and information in these IP packets is fully viewable by computers relaying the packets. It is accordingly possible for an ill-intentioned administrator of a computer functioning as a relay point to surreptitiously view the content of communication between a sender and a recipient (FIG. 3).

In the case of communications implementing an encryption scheme such as SSL, the administrator of a relay point will be unable to ascertain data content simply by viewing packets. However, since other information, namely, the IP header and TCP/UDP header, are unencrypted, it is possible for a relay computer to ascertain the where the communication comes from and where it is destined.

Additionally, a drawback of the IP communication procedure is that the destination device with which it is desired to communicate to exchange information will be able to identify the sender (20 in FIG. 4). This problem can be overcome using multiple anonymous proxies as relay points, by carrying out communication using these relay points so that the sender cannot be identified by the recipient (22 in FIG. 4).

This method, however, has the drawback that the administrators of all of the anonymous proxies will be able to ascertain where the recipient is. Another drawback is that both the sender and the recipient will be exposed to the anonymous proxy to which the client first connects (21 in FIG. 4). Also, since the communication path per se is fixed, it is easy to find the sender.

Rather than using a particular anonymous proxy to prevent this, by instead running a dedicated program having anonymous proxies capabilities and able to be used between oneself and another party (hereinafter termed a peer-to-peer anonymous proxy), and selecting from among these relay points arbitrarily or in a randomized manner, it is possible to set up an anonymous communications channels for transfer of data through peer-to-peer encrypted communication between interacting parties unknown to each other, thereby solving the problem (FIG. 5).

With this method, the initial peer-to-peer anonymous proxy is being run by oneself, and as such can be trusted. Peer-to-peer anonymous proxies serving as relay points cannot determine, from the flow of data over the network, whether another peer-to-peer anonymous proxy to which one has connected is in fact the starting point, or simply another relay point. The reason is that the running peer-to-peer anonymous proxy has two functions, namely, that of the communication starting point, and at the same time that of another communication relay point. Consequently, it is difficult to determine from the outside.

### SUMMARY

Problem the Invention Attempts to Solve

Where communication can actually take place by a method such as that in FIG. 5, considerable communication information can be transmitted without leakage. However, this presumes that all of the relay points are operating normally; in the event that a relay point is a peer-to-peer anonymous proxy that has been modified with malicious intent, secure communication can not always be assured. Specifically, problems such as the following could occur.

Where communication between peer-to-peer anonymous proxies connected together is simply SSL or other encrypted communication, it is possible to prevent a third party monitoring from outside the network from ascertaining which peer-to-peer anonymous proxy is the client which originated the connection. However, since the content of this communications data is decoded within the peer-to-peer anonymous proxies, the administrator of a peer-to-peer anonymous proxy serving as a relay point could find out the destination.

It is possible to make it so that when a peer-to-peer anonymous proxy decides on a peer-to-peer anonymous proxy to serve as the next relay point, the proxy will only be able to ascertain the previous and subsequent IP addresses being relayed by itself. However, if a peer-to-peer anonymous proxy that has been tampered with is present, it is possible that even if the user has instructed that communication pass through more relay points, routing will not take place as instructed, and anonymity may not be assured. In such cases there is no way for the user himself to verify whether the anonymous communication path being used is in fact secure.

Conversely, where the user himself instructs which route to take, while it is possible to verify whether communication has been routed correctly, peer-to-peer anonymous proxies serving as relay points will know the route as well.

Means for Solving the Problem

A user wishing to carry out anonymous communication starts up the peer-to-peer anonymous proxy on the computer that the user is using (1 in FIG. 1); this is deemed the starting point of the anonymous communication path, and designated as peer-to-peer anonymous proxy A. This peer-to-peer anonymous proxy A selects a peer-to-peer anonymous proxy B serving as the next relay point, and connects to it. The two exchange a public key with one another. The peer-to-peer anonymous proxy B generates a unique password for authentication, encrypting it to hide it from devices other than the peer-to-peer anonymous proxy A, and sends this to the peer-to-peer anonymous proxy A (2 in FIG. 1).

The peer-to-peer anonymous proxy A selects a peer-to-peer anonymous proxy C to serve as the next relay point of the peer-to-peer anonymous proxy B, and the peer-to-peer anonymous proxy B connects to the peer-to-peer anonymous proxy C. Here as well, the two exchange a public key with one another. The peer-to-peer anonymous proxy C generates a unique password for authentication, encrypting it to hide it from devices other than the peer-to-peer anonymous proxy A, and sends this to the peer-to-peer anonymous proxy A (2, 3 in FIG. 1).

In the same manner as the peer-to-peer anonymous proxy A connected to the peer-to-peer anonymous proxies B and C, the peer-to-peer anonymous proxy A now connects by a different route to peer-to-peer anonymous proxies D and E, and then accesses the peer-to-peer anonymous proxy B. At this time, the password acquired by the route of 2 in FIG. 1 is encrypted to hide it from devices other than the peer-to-peer anonymous proxy B and is sent to the peer-to-peer anonymous proxy B, whereupon authentication is carried out (4, 5, 6 in FIG. 1).

Further, in the same manner as the peer-to-peer anonymous proxy A connected to the peer-to-peer anonymous proxies B and C, the peer-to-peer anonymous proxy A now connects by a different route to peer-to-peer anonymous proxies F and G, and then accesses the peer-to-peer anonymous proxy C. At this time, the password acquired by the route of 2, 3 in FIG. 1 is encrypted to hide it from devices other than the peer-to-peer anonymous proxy C and is sent to the peer-to-peer anonymous proxy C, whereupon authentication is carried out (7, 8, 9 in FIG. 1).

Where passwords for the peer-to-peer anonymous proxy B and the peer-to-peer anonymous proxy C match, it is verified that the correct routing has taken place as instructed by the peer-to-peer anonymous proxy A. Subsequently, using the route of 2, 3, 10 in FIG. 1, the client accesses an http server or the like, and exchanges data with the server. This data is sent encrypted to the peer-to-peer anonymous proxy A, so that the content thereof cannot be ascertained by any of the relaying peer-to-peer anonymous proxies (2, 3, 10 in FIG. 1; FIG. 5).

A method of creating a communication path while carrying out authentication one by one of the peer-to-peer anonymous proxies to serve as relay points on an anonymous path for exchange of data with a server is also conceivable. In this case, connections would be made in the order 2, 4, 5, 6, 3, 7, 8, 9, 10 in FIG. 1.

Effects of the Invention

Communication is possible without the communication partner (the http server or the like) knowing the original sender. Nor will any proxy other than the end point peer-to-peer anonymous proxy know the destination of the communication. Consequently, the destination of a communication can be concealed from any organization to which a user may belong when connecting to the Internet, such as a company or Internet service provider. The communication partner (the http server or the like) is unknown to any point except the end point peer-to-peer anonymous proxy. Apart from the peer-to-peer anonymous proxy which is the starting point run by the user, the peer-to-peer anonymous proxies of the relay points making up an anonymous communication path do not know of where the original sender of the communication is. With the sender and the destination kept concealed, http, ftp and other such existing Internet services employing TCP or UDP can continue to be used as-is.

The relay points of peer-to-peer anonymous proxies are only aware of the previous and subsequent connection routes, and it is possible to verify that routing has been carried out in the manner specified by the user. Consequently, even if untrustworthy relay points are present, it is possible to form an anonymous communication path that excludes these.

Since the user himself runs the peer-to-peer anonymous proxy for anonymous communication, even if the number of users using an anonymous communication path should increase, the number of end point peer-to-peer anonymous proxies will increase by a corresponding extent, so a drop in speed on the circuit can be easily avoided. In securing an anonymous communication path, by selecting an anonymous communication path in consideration of speed between the peer-to-peer anonymous proxies thereof, it is possible to connect through efficient utilization of networks that are normally empty.

### BRIEF DESCRIPTION OF THE DRAWINGS

FIG. 1 is a diagram of the anonymous communication path securing process;

FIG. 2 is a conceptual diagram of IP packet configuration;

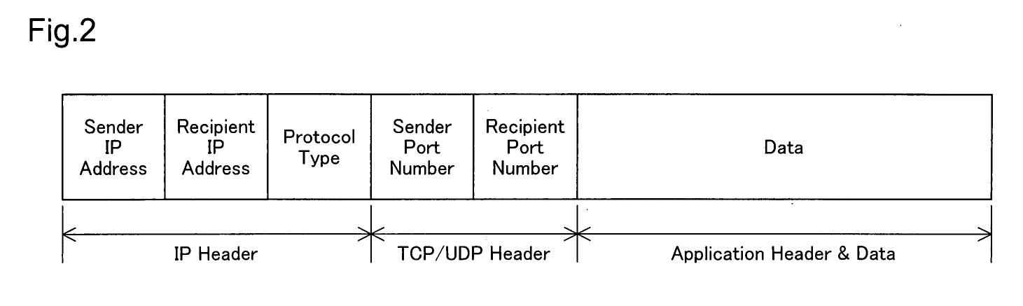

FIG. 3 is a conceptual diagram of connections over the Internet;

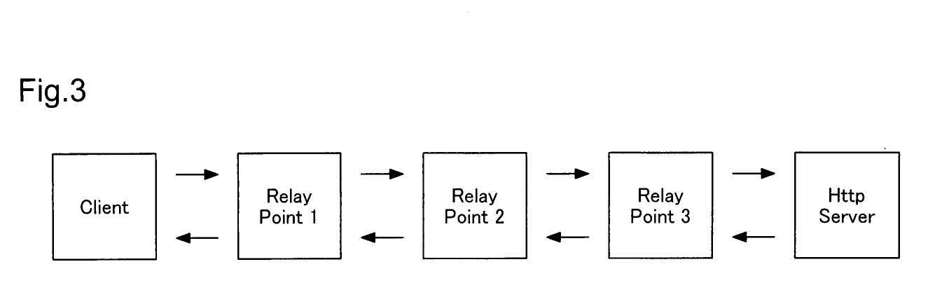

FIG. 4 is a conceptual diagram of connections via anonymous proxies;

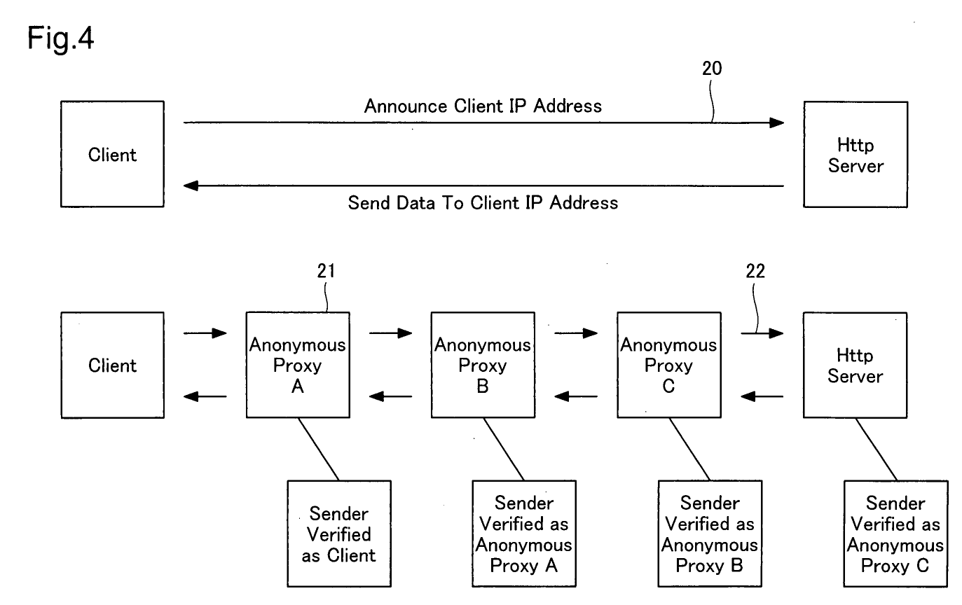

FIG. 5 is a conceptual diagram of anonymous communication via peer-to-peer anonymous proxies;

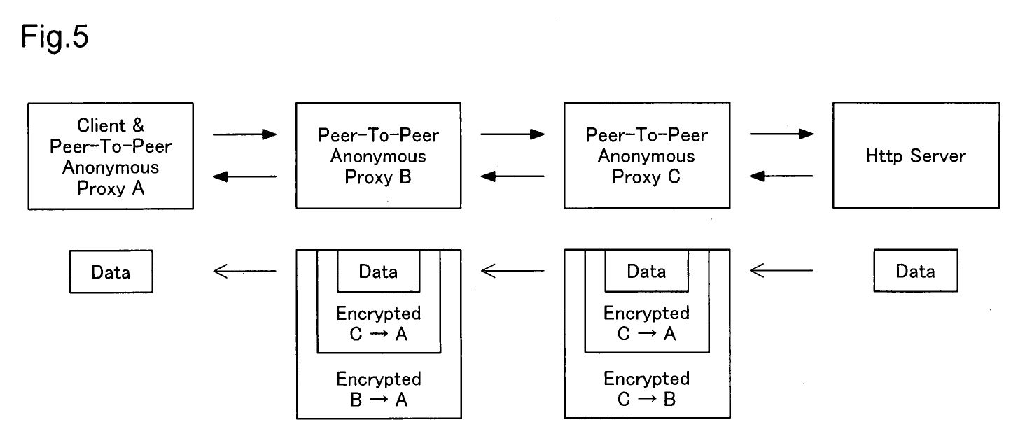

FIG. 6 is a flowchart of operations among peer-to-peer anonymous proxies;

FIG. 7 is a flowchart of operations among peer-to-peer anonymous proxies;

FIG. 8 is a flowchart of operations among peer-to-peer anonymous proxies;

FIG. 9 is a diagram of data determination, creation, and transfer among peer-to-peer anonymous proxies in FIG. 6; and

FIG. 10 is a diagram of data determination, creation, and transfer among peer-to-peer anonymous proxies in FIG. 7.

### BEST MODE FOR CARRYING OUT THE INVENTION

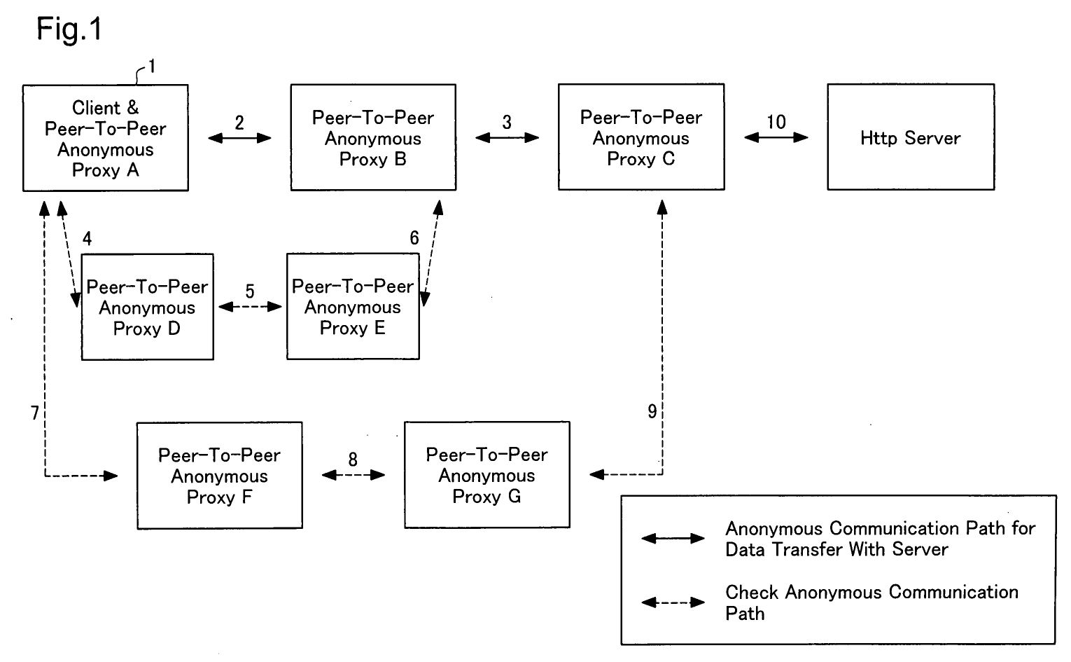

Two types of methods are contemplated, depending on conditions. The format of connection in the order 2, 3, 4, 5, 6, 7, 8, 9, 10 in FIG. 1 is appropriate in cases where reliable relay points are numerous. The reason is that it is possible to simultaneously access the routes 4, 5, 6 and 7, 8, 9. The format of connection in the order 2, 4, 5, 6, 3, 7, 8, 9, 10 in FIG. 1 is appropriate in cases where unreliable relay points are numerous. The reason is that once an anonymous communication path for exchanging data with a server has been created, in the event that through subsequent verification the existence of an unauthorized peer-to-peer anonymous proxy is discovered, the anonymous communication path for exchanging data with the server must be created again from the beginning. These methods involve the same basic exchange, and differ only in terms of the order of setting up the anonymous communication path for exchanging data with the server and the anonymous verification communication path. Accordingly, the former shall be described in the embodiment hereinbelow.

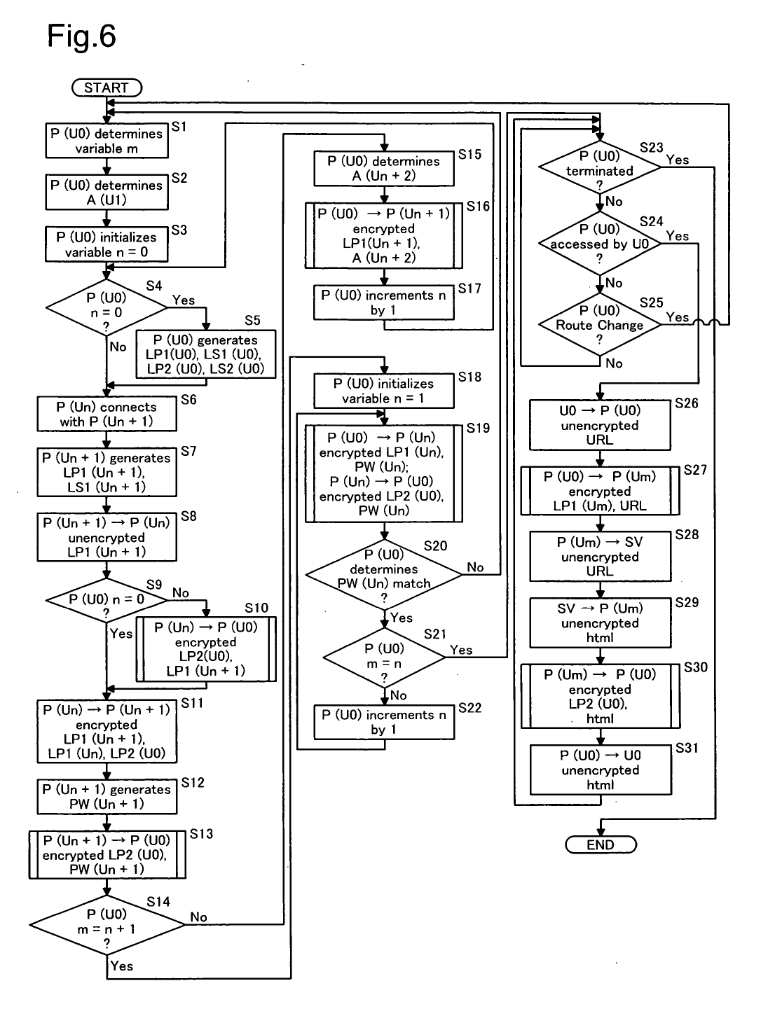

FIG. 6 is a flowchart of creation of an anonymous communication path. A user U0 desiring to access an http server or other server SV first runs a peer-to-peer anonymous proxy P (U0). Then, the user U0 determines an internal variable m of P (U0) indicating how many peer-to-peer anonymous proxies the path should pass through as relay points (Step S1). Subsequently, P (U0) selects at random one address from a list of IP addresses of other peer-to-peer anonymous proxies, which it maintains internally (Step S2). The selected IP address is designated as A (U1), and serves as the next relay point of P (U0). P (U0) initializes to 0 an internal variable n that indicates the number of peer-to-peer anonymous proxies currently relaying (Step S3).

In the event that n=0 (Step S4), P (U0) generates a public key LP1 (U0) and a corresponding private key LS1 (U0), and a public key LP2 (U0) and a corresponding private key LS2 (U0) (Step S5).

P (Un) connects to P (Un+1) whose IP address is A (Un+1) (Step S6). P (Un+1) generates a public key LP1 (Un+1) and a corresponding private key LS1 (Un+1) (Step S7). The public key LP1 (Un+1) is then sent unencrypted from P (Un+1) to P (Un) (Step S8). P (Un) receives the data thereof

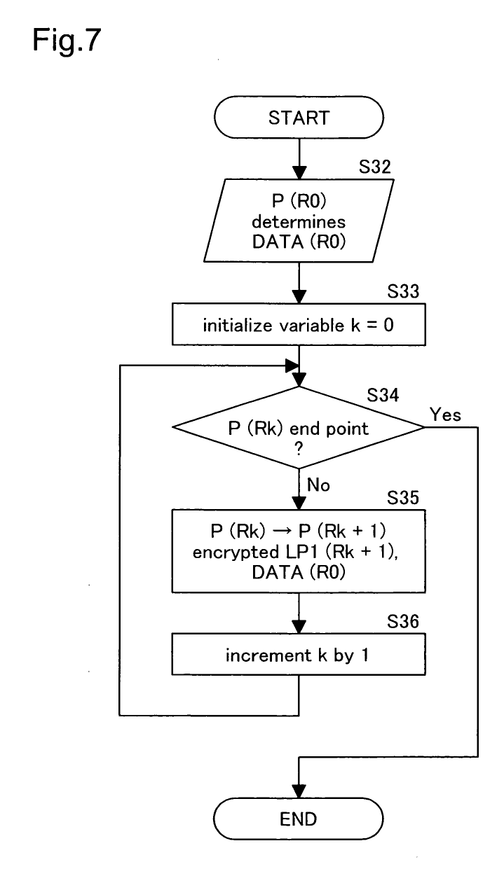

In the event that the variable n is not 0 (Step S9), the public key LP1 (Un+1) encrypted with a public key LP2 (U0) is sent from P (Un) to P (U0). P (U0) decrypts the received data with a private key LS2 (U0) (Step S10). At this time, data is not sent directly from P (Un) to P (U0), but rather sent to P (U0) in order from P (Un) to P (Un−1) and then from P (Un−1) to P (Un−2), while implementing encrypted communication among relay points connected next to one another (FIG. 7).

In the flowchart of FIG. 7, P (R0) is the same peer-to-peer anonymous proxy as P (Un). DATA (R0) corresponds to the public key LP1 (Un+1) encrypted with the public key LP2 (U0) in Step S10 of FIG. 6 (Step S32). The variable k is for convenience in describing the flowchart (Step S33); this variable does not exist in any of the peer-to-peer anonymous proxies. In the event that P (Rk) and P (U0) do not match (Step S34), the DATA (R0) is encrypted with a public key LP1 (Rk+1) and sent from P (Rk) to P (Rk+1) (Step S35). Here, P (Rk) corresponds to P (Un−k), P (Rk+1) to P (Un−k−1), and the public key LP1 (Rk+1) to the public key LP1 (Un−k−1). Subsequently, 1 is added to the variable k, and the process jumps to Step S34 of FIG. 7 (Step S36). In the event that P (Rk) and P (U0) match (Step S34), the process jumps to Step S11 of FIG. 6.

The public key LP1 (Un) and the public key LP2 (U0), encrypted with the public key LP1 (Un+1), are sent from P (Un) to P (Un+1). P (Un+1) decrypts the received data with the private key LS1 (Un+1) (Step S11).

P (Un+1) now generates a unique password PW (Un+1) (Step S12). The password PW (Un+1), encrypted with the public key LP2 (U0), is sent from P (Un+1) to P (U0). P (U0) decrypts the received data with the private key LS2 (U0) (Step S13). At this time, data is not sent directly from P (Un+1) to P (U0), but rather sent to P (U0) in the order from P (Un+1) to P (Un) and then from P (Un) to P (Un−1), while implementing encrypted communication among relay points connected next to one another (FIG. 7).

In the flowchart of FIG. 7, P (R0) is the same peer-to-peer anonymous proxy as P (Un+1). DATA (R0) corresponds to the unique password PW (Un+1) encrypted with the public key LP2 (U0) in Step S13 of FIG. 6 (Step S32). The variable k is for convenience in describing the flowchart (Step S33); this variable does not exist in any of the peer-to-peer anonymous proxies. In the event that P (Rk) and P (U0) do not match (Step S34), the DATA (R0) encrypted with the public key LP1 (Rk+1) is sent from P (Rk) to P (Rk+1) (Step S35). Here, P (Rk) corresponds to P (Un+1−k), P (Rk+1) to P (Un−k), and the public key LP1 (Rk+1) to the public key LP1 (Un−k). Subsequently, 1 is added to the variable k, and the process jumps to Step S34 of FIG. 7 (Step S36). In the event that P (Rk) and P (U0) match (Step S34), the process jumps to Step S14 of FIG. 6.

P (U0) now verifies whether m=n+1 is true. If true, the process jumps to Step S18; if not true, the process jumps to Step S15 (Step S14). P (U0) selects at random one address from a list of IP addresses of other peer-to-peer anonymous proxies, which it maintains internally (Step S15). The selected IP address is designated as A (Un+2), and serves as the next relay point of P (Un+1). The IP address A (Un+2), encrypted with the public key LP1 (Un+1), is sent from P (U0) to P (Un+1). P (Un+1) decrypts the received data with the private key LS1 (Un+1) (Step S16). At this time, data is not sent directly from P (U0) to P (Un+1), but rather sent to P (Un+1) in order from P (U0) to P (U1) and the from P (U1) to P (U2), while implementing encrypted communication among relay points connected next to one another (FIG. 7).

In the flowchart of FIG. 7, P (R0) is the same peer-to-peer anonymous proxy as P (U0). DATA (R0) corresponds to the IP address A (Un+2) encrypted with the public key LP1 (Un+1) in Step S16 of FIG. 6 (Step S32). The variable k is for convenience in describing the flowchart (Step S33); this variable does not exist in any of the peer-to-peer anonymous proxies. In the event that P (Rk) and P (Un+1) do not match (Step S34), the DATA (R0) encrypted with the public key LP1 (Rk+1) is sent from P (Rk) to P (Rk+1) (Step S35). Here, P (Rk) corresponds to P (Uk), P (Rk+1) to P (Uk+1), and the public key LP1 (Rk+1) to the public key LP1 (Uk+1). Subsequently, 1 is added to the variable k, and the process jumps to Step S34 of FIG. 7 (Step S36). In the event that P (Rk) and P (Un+1) match (Step S34), the process jumps to Step S16 of FIG. 6.

P (U0) adds 1 to n, and jumps to Step S4 (Step S17).

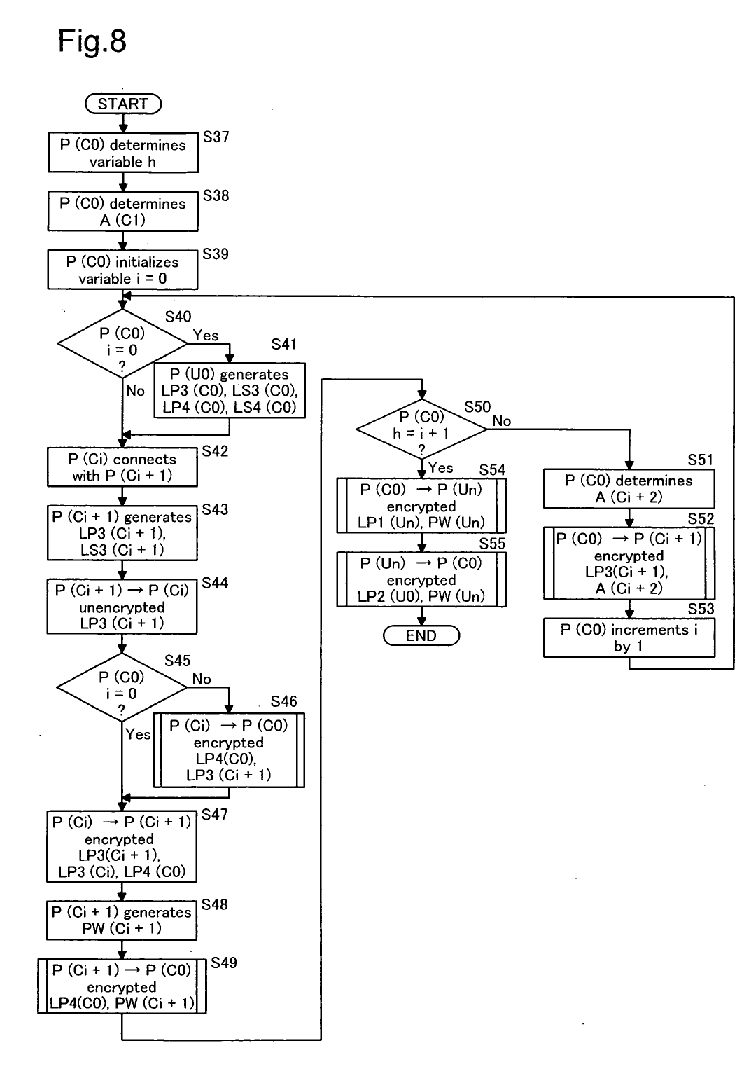

P (U0) initializes to 1 the internal variable n (Step S18). P (U0) connects to P (Un), sends to P (Un) the password received in Step S13, and receives from P (Un) an identical password or return value (Step S19, FIG. 8)

The flowchart of FIG. 8 will now be described. From Step S37 to Step S53 of FIG. 8, the flow is substantially the same as that from Step S1 to Step S17 of FIG. 6. C0 and U0 are the same user, and the peer-to-peer anonymous proxy P (C0) is the same as P (U0). Where n>0 or i>0, Un and Ci are all different users, and P (Un) and P (Ci) are all different peer-to-peer anonymous proxies. Here, a user C0 (=U0) desiring to access P (Un) first determines an internal variable h of P (U0) indicating how many peer-to-peer anonymous proxies the path should pass through as relay points (Step S37). Subsequently, a peer-to-peer anonymous proxy P (C0) (=P (U0)) run by the user C0 selects at random one address from a list of IP addresses of other peer-to-peer anonymous proxies, which it maintains internally (Step S38). The selected IP address is designated as A (C1), and serves as the next relay point of P (C0). P (U0) initializes to 0 an internal variable i (Step S39).

In the event that i=0 (Step S40), P (C0) generates a public key LP3 (C0) and a corresponding private key LS3 (C0), and a public key LP4 (C0) and a corresponding private key LS4 (C0) (Step S41).

P (Ci) connects to P (Ci+1) whose IP address is A (Ci+1) (Step S42). P (Ci+1) generates a public key LP3 (Ci+1) and a corresponding private key LS3 (Ci+1) (Step S43). The public key LP3 (Ci+1) is then sent unencrypted from P (Ci+1) to P (Ci) (Step S44). P (Ci) receives the data thereof.

In the event that the variable i is not 0 in P (C0) (Step S45), the public key LP3 (Ci+1) encrypted with a public key LP4 (C0) is sent from P (Ci) to P (C0). P (C0) decrypts the received data with the private key LS4 (C0) (Step S46). At this time, data is not sent directly from P (Ci) to P (C0), but rather sent to P (C0) in from order from P (Ci) to P (Ci−1) and then from P (Ci−1) to P (Ci−2), while implementing encrypted communication among relay points connected next to one another (FIG. 7).

In the flowchart of FIG. 7, P (R0) is the same peer-to-peer anonymous proxy as P (Ci). DATA (R0) corresponds to the public key LP3 (Ci+1) encrypted with the public key LP4 (C0) in Step S46 of FIG. 8 (Step S32). The variable k is for convenience in describing the flowchart (Step S33); this variable does not exist in any of the peer-to-peer anonymous proxies. In the event that P (Rk) and P (C0) do not match (Step S34), the DATA (R0) encrypted with a public key LP1 (Rk+1) is sent from P (Rk) to P (Rk+1) (Step S35). Here, P (Rk) corresponds to P (Ci−k), P (Rk+1) to P (Ci−k−1), and the public key LP1 (Rk+1) to the public key LP3 (Ci−k−1). Subsequently, 1 is added to the variable k, and the process jumps to Step S34 of FIG. 7 (Step S36). In the event that P (Rk) and P (C0) match (Step S34), the process jumps to Step S47 of FIG. 8.

The public key LP3 (Ci) and the public key LP4 (C0), encrypted with the public key LP3 (Ci+1), are sent from P (Ci) to P (Ci+1). P (Ci+1) decrypts the received data with the private key LS3 (Ci+1) (Step S47).

P (Ci+1) now generates a unique password PW (Ci+1) (Step S48). The password PW (Ci+1), encrypted with the public key LP4 (C0), is sent from P (Ci+1) to P (C0). However, since the current path is the anonymous verification communication path of FIG. 1, this password is not used. The process of sending a password to the relaying peer-to-peer anonymous proxy is performed because it has not been determined whether the path is a data transfer anonymous communication path or a check anonymous communication path. P (C0) decrypts the received data with the private key LS4 (C0) (Step S49). At this time, data is not sent directly from P (Ci+1) to P (C0), but rather sent to P (C0) in order from P (Ci+1) to P (Ci) and then from P (Ci) to P (Ci−1), while implementing encrypted communication among relay points connected next to one another (FIG. 7).

In the flowchart of FIG. 7, P (R0) is the same peer-to-peer anonymous proxy as P (Ci+1). DATA (R0) corresponds to the unique password PW (Ci+1) encrypted with the public key LP4 (C0) in Step S49 of FIG. 8 (Step S32). The variable k is for convenience in describing the flowchart (Step S33); this variable does not exist in any of the peer-to-peer anonymous proxies. In the event that P (Rk) and P (C0) do not match (Step S34), the DATA (R0) encrypted with the public key LP1 (Rk+1) is sent from P (Rk) to P (Rk+1) (Step S35). Here, P (Rk) corresponds to P (Ci+1−k), P (Rk+1) to P (Ci−k), and the public key LP1 (Rk+1) to the public key LP3 (Ci−k). Subsequently, 1 is added to the variable k, and the process jumps to Step S34 of FIG. 7 (Step S36). In the event that P (Rk) and P (C0) match (Step S34), the process jumps to Step S50 of FIG. 8.

P (C0) now verifies whether h=i+1 is true. If true, the process jumps to Step S54; if not true, the process jumps to Step S51 (Step S50). P (C0) selects at random one address from a list of IP addresses of other peer-to-peer anonymous proxies, which it maintains internally (Step S51). The selected IP address is designated as A (Ci+2), and serves as the next relay point of P (Ci+1). The IP address A (Ci+2), encrypted with the public key LP3 (Ci+1), is sent from P (C0) to P (Ci+1). P (Ci+1) decrypts the received data with the private key LS3 (Ci+1) (Step S52). At this time, data is not sent directly from P (C0) to P (Ci+1), but rather sent to P (Ci+1) in order from P (C0) to P (C1) and then from P (C1) to P (C2), while implementing encrypted communication among relay points connected next to one another (FIG. 7).

In the flowchart of FIG. 7, P (R0) is the same peer-to-peer anonymous proxy as P (C0). DATA (R0) corresponds to the IP address A (Ci+2) encrypted with the public key LP3 (Ci+1) in Step S52 of FIG. 8 (Step S32). The variable k is for convenience in describing the flowchart (Step S33); this variable does not exist in any of the peer-to-peer anonymous proxies. In the event that P (Rk) and P (Ci+1) do not match (Step S34), the DATA (R0) encrypted with the public key LP1 (Rk+1) is sent from P (Rk) to P (Rk+1) (Step S35). Here, P (Rk) corresponds to P (Ck), P (Rk+1) to P (Ck+1), and the public key LP1 (Rk+1) to the public key LP3 (Ck+1). Subsequently, 1 is added to the variable k, and the process jumps to Step S34 of FIG. 7 (Step S36). In the event that P (Rk) and P (Ci+1) match (Step S34), the process jumps to Step S53 of FIG. 8.

P (C0) adds 1 to i, and jumps to Step S40 (Step S53).

The password PW (Un) encrypted with the public key LP1 (Un) and received in Step S13 of FIG. 6 is sent from P (C0) to P (Un). P (Un) decrypts the received data with the private key LS1 (Un) (Step S54). At this time, data is not sent directly from P (C0) to P (Un), but rather sent to P (Un) in order from P (C0) to P (C1) and then from P (C1) to P (C2), while implementing encrypted communication among relay points connected next to one another (FIG. 7).

In the flowchart of FIG. 7, P (R0) is the same peer-to-peer anonymous proxy as P (C0). DATA (R0) corresponds to the password PW (Un) encrypted with the public key LP1 (Un) in Step S54 of FIG. 8 (Step S32). The variable k is for convenience in describing the flowchart (Step S33); this variable does not exist in any of the peer-to-peer anonymous proxies. In the event that P (Rk) and P (Un) do not match (Step S34), the DATA (R0) encrypted with the public key LP1 (Rk+1) is sent from P (Rk) to P (Rk+1) (Step S35). Here, P (Rk) corresponds to P (Uk), P (Rk+1) to P (Uk+1), and the public key LP1 (Rk+1) to the public key LP1 (Uk+1). Subsequently, 1 is added to the variable k, and the process jumps to Step S34 of FIG. 7 (Step S36). In the event that P (Rk) and P (C0) match (Step S34), the process jumps to Step S55 of FIG. 8.

P (Un) verifies whether the decrypted data matches the password group created by P (Un) within a prescribed time interval in the past. If there is a match, the password PW (Un), encrypted with the public key LP2 (U0), is sent back from P (Un) to P (C0). In the event that the data sent from P (C0) cannot be decrypted, or in the event that the passwords do not match, content indicating this is sent back to P (C0). P (C0) decrypts the received data with the private key LS2 (U0) (Step S55). At this time, data is not sent directly from P (Un) to P (C0), but rather sent to P (Un) in order from P (Un) to P (Ch) and the from P (Ch) to P (Ch−1), while implementing encrypted communication among relay points connected next to one another (FIG. 7).

In the flowchart of FIG. 7, P (R0) is the same peer-to-peer anonymous proxy as P (Un). DATA (R0) corresponds to the password PW (Un) encrypted with the public key LP2 (U0) in Step S55 of FIG. 8 (Step S32), or where the passwords do not match in P (Un), to content indicating this. The variable k is for convenience in describing the flowchart (Step S33); this variable does not exist in any of the peer-to-peer anonymous proxies. In the event that P (Rk) and P (C0) do not match (Step S34), the DATA (R0) encrypted with the public key LP1 (Rk+1) is sent from P (Rk) to P (Rk+1) (Step S35). Here, when k=0 P (Rk) corresponds to P (Un) or when k>0 P (Rk) to P (Ch+1−k), P (Rk+1) to P (Ch−k), and the public key LP1 (Rk+1) to the public key LP1 (Ch−k). Subsequently, 1 is added to the variable k, and the process jumps to Step S34 of FIG. 7 (Step S36). In the event that P (Rk) and P (C0) match (Step S34), the process jumps to Step S20 of FIG. 6.

P (U0) decrypts with the private key LS2 (U0) the data sent back from P (Un) (Step S55), but in the event that that at this time the data cannot be decrypted correctly or the data differs from the password P (Un) (Step S20), it can be determined that either the anonymous communication path for data exchange is not routed through the peer-to-peer anonymous proxy P (Un) of the IP address A (Un) instructed by P (U0), or a peer-to-peer anonymous proxy on the anonymous verification communication path is not operating properly. Consequently, the anonymous communication path currently set up is deemed unreliable, and the process jumps to Step S1 of FIG. 6, wherein a new anonymous communication path using peer-to-peer anonymous proxies with different IP addresses than those used currently is secured. In the event that the passwords P (Un) exchanged between P (U0) and P (Un) match (Step S20), the process jumps to Step S21 of FIG. 6.

P (U0) now verifies whether the variables m and n match (Step S21). In the event that these match, checking has been completed for all of the peer-to-peer anonymous proxies on the anonymous communication path for data exchange, and the process now jumps to Step S23 of FIG. 6. Conversely, if the variables m and n do not match (Step S21), checking has not been completed for all of the peer-to-peer anonymous proxies on the anonymous communication path for data exchange, so P (U0) adds 1 to the variable n (Step S22) and jumps to Step S19 of FIG. 6 to continue checking.

P (U0) now ascertains whether there is a Terminate command from the user U0 (Step S23). In the event there is a Terminate command, securing of the anonymous communication path is suspended and terminated. In the absence of a Terminate command, it is ascertained whether the user U0 has accessed P (U0) using a Web browser or the like (Step S24). Where there has been access, the process jumps to Step S26 of FIG. 6, or in the absence of access, the process jumps to Step S25 of FIG. 6. It is then ascertained whether there is a Route Change command from the user U0 (Step S25). In the event there is a Route Change command, the process jumps to Step S1 of FIG. 6, and re-secures an anonymous communication path for data exchange. In the absence of a Route Change command, the process jumps to Step S23 of FIG. 6, and the process is repeated.

The user U0 himself runs the peer-to-peer anonymous proxy P (U0), and connects to it from a Web browser. Next, the URL it is desired to access is sent, without encryption, to P (U0) from U0's Web browser (Step S26). In this case, the computer operated by U0 and the computer on which the peer-to-peer anonymous proxy is present are either the same or located on the same node network, so the unencrypted content is hidden. Where not on the same node, or where it is desired to encrypt despite being located on the same node network, this may not always the case, however. Subsequently, the URL received from the user U0, encrypted with a public key LP1 (Um), is sent from P (U0) to P (Um). P (Um) decrypts the received data using a private key LS1 (Um) (Step S27). At this time, the data is not sent directly from P (U0) to P (Um), but rather sent to P (Um) in order from P (U0) to P (U1) and the from P (U1) to P (U2), while implementing encrypted communication among relay points connected next to one another (FIG. 7).

In the flowchart of FIG. 7, P (R0) is the same peer-to-peer anonymous proxy as P (U0). DATA (R0) corresponds to the user U0;s request URL encrypted with the public key LP1 (Um) in Step S27 of FIG. 6 (Step S32). The variable k is for convenience in describing the flowchart (Step S33); this variable does not exist in any of the peer-to-peer anonymous proxies. In the event that P (Rk) and P (Um) do not match (Step S34), the DATA (R0) encrypted with the public key LP1 (Rk+1) is sent from P (Rk) to P (Rk+1) (Step S35). Here, P (Rk) corresponds to P (Uk), P (Rk+1) to P (Uk+1), and the public key LP1 (Rk+1) to the public key LP1 (Uk+1). Subsequently, 1 is added to the variable k, and the process jumps to Step S34 of FIG. 7 (Step S36). In the event that P (Rk) and P (Um) match (Step S34), the process jumps to Step S28 of FIG. 6.

P (Um) having received the URL now accesses the Web server SV having that URL (Step S28). It then retrieves data html from the server SV (Step S29). While this communication is not encrypted, in the event that the Web server per se is encrypted by SSL or the like, this may not always the case, however.

The data html retrieved from the server SV, encrypted with the public key LP2 (U0), is sent from P (Um) to P (U0). P (Um) decrypts the received data using the private key LS2 (U0) (Step S30). At this time, the data is not sent directly from P (Um) to P (U0), but rather sent to P (U0) in order from P (Um) to P (Um−1) and then from P (Um−1) to P (Um−2), while implementing encrypted communication among relay points connected next to one another (FIG. 7).

In the flowchart of FIG. 7, P (R0) is the same peer-to-peer anonymous proxy as P (Um). DATA (R0) corresponds to the data html from SV encrypted with the public key LP2 (U0) in Step S30 of FIG. 6 (Step S32). The variable k is for convenience in describing the flowchart (Step S33); this variable does not exist in any of the peer-to-peer anonymous proxies. In the event that P (Rk) and P (U0) do not match (Step S34), the DATA (R0) encrypted with the public key LP1 (Rk+1) is sent from P (Rk) to P (Rk+1) (Step S35). Here, P (Rk) corresponds to P (Um−k), P (Rk+1) to P (Um−k−1), and the public key LP1 (Rk+1) to the public key LP1 (Um−k−1). Subsequently, 1 is added to the variable k, and the process jumps to Step S34 of FIG. 7 (Step S36). In the event that P (Rk) and P (U0) match (Step S34), the process jumps to Step S31 of FIG. 6.

The data html is sent, without encryption, from P (U0) which has received the data, to the Web browser being used by the user U0 (Step S31). In this case, the computer operated by U0 and the computer on which the peer-to-peer anonymous proxy is present are either the same or located on the same node network, so the unencrypted content is hidden. Where not on the same node, or where it is desired to encrypt despite being located on the same node network, this may not always the case, however. The process from Step S23 to Step S31 of FIG. 6 is repeated as needed commensurate with data transfer to and from this web server SV.

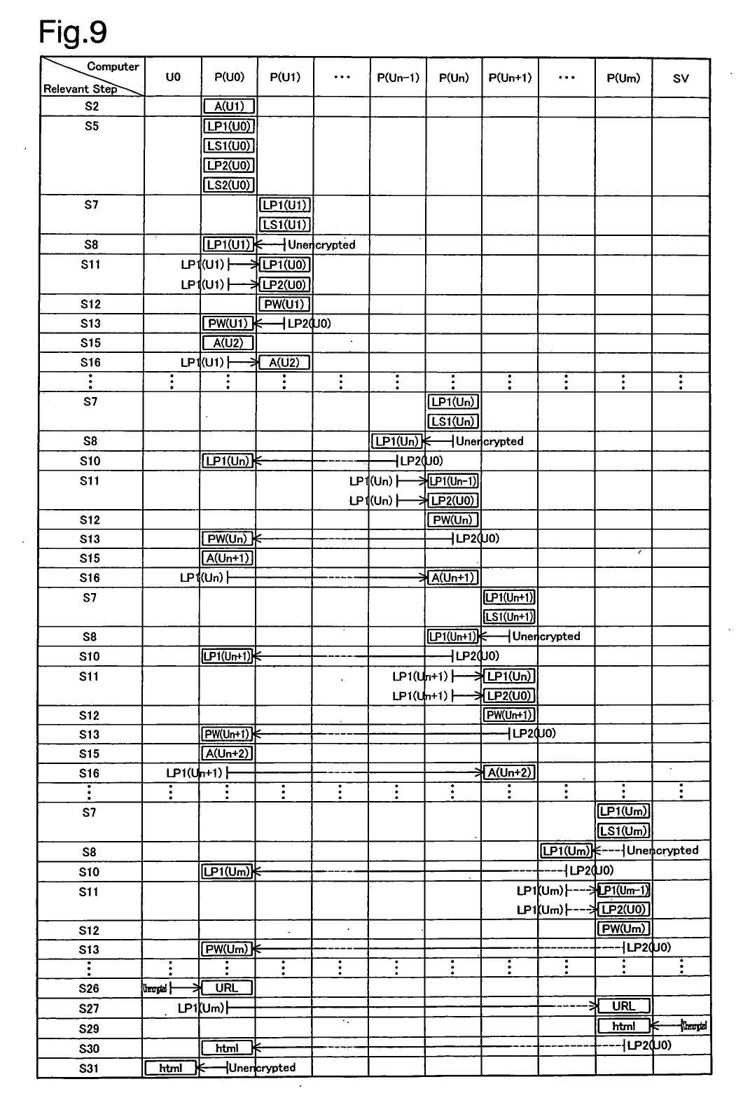

These procedures in FIG. 6 for determining, generating, and exchanging data over an anonymous communication path from the user U0 to the server SV are represented in FIG. 9. The user U0, the peer-to-peer anonymous proxy, and the server SV in data exchange are noted in the Computer entries. The steps in the flowchart of FIG. 6 are indicated by the Relevant Steps. The table is chronological from top to bottom. Since the flowchart of FIG. 8 has data flow substantially identical to that of FIG. 6, a diagram of data determination, generation, and exchange over an anonymous communication path corresponding to FIG. 8 has been omitted.

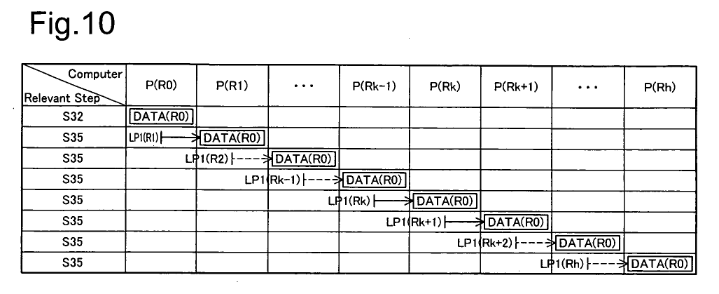

Data exchange between peer-to-peer anonymous proxies in FIG. 7 is depicted in FIG. 10. Peer-to-peer anonymous proxies are noted in the Computer entries, and the flow of data where transmitted from P (R0) to P (Rh) is depicted. The steps in the flowchart of FIG. 7 are indicated by the Relevant Steps. The table is chronological from top to bottom.

Obviously, the identitification and generation of the password may be performed either side of proxy A or proxy B, C in FIG. 1, and the password routing, using the encrypted anonymous verification path invented by this inventor as shown in the above embodiment, has many available options for one skilled in the art at the time of the Japanese Patent Application, all of which are included in the scope of the claim set.

Two Patent Applications listed below are incorporated herein by reference.
(1) Japanese Patent Application 2004-77168 (Application Date: Feb. 19, 2004)
(2) International Application PCT/JP2005/003242 (Application Date: May 31, 2004)

### INDUSTRIAL APPLICABILITY

Through the use of this method, it is possible to ensure the privacy of individuals using the Internet, without relying on anonymous proxy provided by an Internet service provider or a specific organization.

Currently, individual access information domestically is administered stringently by providers. As long as certain conditions are met, this can prevent viewing by a third party. However, currently there exists a risk that individual information could be exposed through administration error on the provider side, or through internal or external hacking.

Since one can protect oneself from such risks personally, protection of privacy and confidentiality are carried out more easily. User misgivings as to data leakage over the Internet are eliminated, thus promoting use of the Internet.

Through the use of this system, it is possible to securely the protect the identity of a poster using the Internet to make internal posts, for example. Consequently, internal whistle-blowing in a company or organization can be promoted, which can play a part in building sound companies and economic formation.

1. A communication method comprising:
providing a terminal anonymous proxy server that functions as a user terminal for a specific user and also functions as an anonymous proxy server for a user other than the specific user via a network;
creating an encrypted anonymous communication path from the terminal anonymous proxy server to a destination anonymous proxy server directly connected to a destination server that the specific user desires to communicate with via at least one relay anonymous proxy server;
creating an encrypted anonymous verification paths from the terminal anonymous proxy server to each of the at least one relay anonymous proxy server and to the destination anonymous proxy server, the encrypted anonymous verification paths being different from the encrypted anonymous communication path, the encrypted anonymous verification paths being for verifying the encrypted anonymous communication path; and
verifying the encrypted anonymous communication path based on a preservation of an identity of a password when being transmitted via the encrypted anonymous verification path.

2. The communication method in accordance with claim 1, wherein
the step of creating the encrypted anonymous communication path comprises the step of extending the encrypted anonymous communication path from the terminal anonymous proxy server to the destination anonymous proxy server by verifying a encrypted anonymous communication path from the terminal anonymous proxy server to each relay anonymous proxy server one by one.

3. The communication method in accordance with claim 1, wherein
the step of verifying the encrypted anonymous communication path comprises the step of verifying the encrypted anonymous communication path based on the preservation of the identity of the password when being transmitted via the encrypted anonymous communication path.

4. The communication method in accordance with claim 2, wherein
the step of verifying the encrypted anonymous communication path comprises the step of verifying the encrypted anonymous communication path based on the preservation of the identity of the password when being transmitted via the encrypted anonymous communication path.

5. A communication system comprising:
a terminal anonymous proxy server that functions as a user terminal for a specific user and also functions as an anonymous proxy server for a user other than the specific user via a network;
a means for creating an encrypted anonymous communication path from the terminal anonymous proxy server to a destination anonymous proxy server directly connected to a destination server that the specific user desires to communicate with via at least one relay anonymous proxy server;
a means for creating an encrypted anonymous verification paths from the terminal anonymous proxy server to each of the at least one relay anonymous proxy server and to the destination anonymous proxy server, the encrypted anonymous verification paths being different from the encrypted anonymous communication path, the encrypted anonymous verification paths being for verifying the encrypted anonymous communication path; and
a means for verifying the encrypted anonymous communication path based on a preservation of an identity of a password when being transmitted via the encrypted anonymous verification path.

6. The communication system in accordance with claim 5, wherein
the means for creating the encrypted anonymous communication path comprises the means for extending the encrypted anonymous communication path from the terminal anonymous proxy server to the destination anonymous proxy server by verifying a encrypted anonymous communication path from the terminal anonymous proxy server to each relay anonymous proxy server one by one.

7. The communication system in accordance with claim 5, wherein
the means for verifying the encrypted anonymous communication path comprises the means for verifying the encrypted anonymous communication path based on the preservation of the identity of the password when being transmitted via the encrypted anonymous communication path.

8. The communication system in accordance with claim 6, wherein
the means for verifying the encrypted anonymous communication path comprises the means for verifying the encrypted anonymous communication path based on the preservation of the identity of the password when being transmitted via the encrypted anonymous communication path.

9. A terminal anonymous proxy server that functions as a user terminal for a specific user and also functions as an anonymous proxy server for a user other than the specific user via a network, the terminal anonymous proxy server performs the functions of:
creating an encrypted anonymous communication path from the terminal anonymous proxy server to a destination anonymous proxy server directly connected to a destination server that the specific user desires to communicate with via at least one relay anonymous proxy server;
creating an encrypted anonymous verification paths from the terminal anonymous proxy server to each of the at least one relay anonymous proxy server and to the destination anonymous proxy server, the encrypted anonymous verification paths being different from the encrypted anonymous communication path, the encrypted anonymous verification paths being for verifying the encrypted anonymous communication path; and
verifying the encrypted anonymous communication path based on a preservation of an identity of a password when being transmitted via the encrypted anonymous verification path.

10. The terminal anonymous proxy server in accordance with claim 9, wherein
the functions of creating the encrypted anonymous communication path includes the function of extending the encrypted anonymous communication path from the terminal anonymous proxy server to the destination anonymous proxy server by verifying a encrypted anonymous communication path from the terminal anonymous proxy server to each relay anonymous proxy server one by one.

11. The terminal anonymous proxy server in accordance with claim 9, wherein
the functions of verifying the encrypted anonymous communication path includes the function of verifying the encrypted anonymous communication path based on the preservation of the identity of the password when being transmitted via the encrypted anonymous communication path.

12. The terminal anonymous proxy server in accordance with claim 10, wherein
the functions of verifying the encrypted anonymous communication path includes the function of verifying the encrypted anonymous communication path based on the preservation of the identity of the password when being transmitted via the encrypted anonymous communication path.

13. A computer program product for causing a computer to function as a user terminal for a specific user and also function as an anonymous proxy server for a user other than the specific user via a network, the computer program product comprising:
a computer readable medium; and
a computer program stored on the computer readable medium, the computer program comprising:
a first program for the computer to create an encrypted anonymous communication path from the terminal anonymous proxy server to a destination anonymous proxy server directly connected to a destination server that the specific user desires to communicate with via at least one relay anonymous proxy server;
a second program for the computer to create an encrypted anonymous verification paths from the terminal anonymous proxy server to each of the at least one relay anonymous proxy server and to the destination anonymous proxy server, the encrypted anonymous verification paths being different from the encrypted anonymous communication path, the encrypted anonymous verification paths being for verifying the encrypted anonymous communication path; and
a third program for the computer to verify the encrypted anonymous communication path based on a preservation of an identity of a password when being transmitted via the encrypted anonymous verification path.

14. The computer program product in accordance with claim 13, wherein
the first program includes a program for the computer to extend the encrypted anonymous communication path from the terminal anonymous proxy server to the destination anonymous proxy server by verifying a encrypted anonymous communication path from the terminal anonymous proxy server to each relay anonymous proxy server one by one.

15. The computer program product in accordance with claim 13, wherein
the third program for the computer to verify the encrypted anonymous communication path includes a program for the computer to verify the encrypted anonymous communication path based on the preservation of the identity of the password when being transmitted via the encrypted anonymous communication path.

16. The computer program product in accordance with claim 14, wherein
the third program for the computer to verify the encrypted anonymous communication path includes a program for the computer to verify the encrypted anonymous communication path based on the preservation of the identity of the password when being transmitted via the encrypted anonymous communication path.
